(19) United States
(12) Patent Application Publication
(10) Pub. No.: US 2015/0026285 A1
(43) Pub. Date: Jan. 22, 2015

(54) SYSTEMS AND METHODS FOR AN EQUIPMENT MANAGEMENT SYSTEM

(71) Applicant: Carrier Commercial Refrigeration, Inc., Farmington, CT (US)

(72) Inventors: Allen E. Stabenow, Freeport, IL (US); Bridget Mcmillan, Beloit, WI (US)

(73) Assignee: Carrier Commercial Refrigeration, Inc., Farmington, CT (US)

(21) Appl. No.: 14/333,062

(22) Filed: Jul. 16, 2014

Related U.S. Application Data
(60) Provisional application No. 61/856,366, filed on Jul. 19, 2013.

(51) Int. Cl. H04L 12/58; H04L 12/26; H04L 12/24

(52) U.S. Cl. CPC H04L 51/26; H04L 41/04; H04L 43/04
USPC 709/207; 709/224

(57) ABSTRACT

The systems and methods described herein provide a link between food service machines and various remotely located databases, thus reducing the cost of ownership for customers and reducing warranty demands for manufacturers. Monitoring information is provided from machines to system and maintenance personnel, including detailed information about malfunctions detected. Further, operating details are communicated from machines enabling machines designers to analyze and predict future performance.

### CROSS-REFERENCE TO RELATED APPLICATION

This application claims priority to and the benefits of U.S. Provisional Patent Application No. 61/856,366, filed Jul. 19, 2013 and which is incorporated by reference herein in its entirety.

### FIELD OF THE INVENTION

The present invention relates to machines having diagnostic communication systems in general, and more particularly, to remotely monitoring and maintaining networked machines.

### BACKGROUND OF THE INVENTION

Current equipment monitoring for food service equipment consists of a haphazard collection of communication systems that are not consolidated, thus causing difficulty in managing food service equipment assets, gathering feedback on performance, providing access to a history of maintenance issues, improving energy efficiency, and contributing to overall food safety management. This results in greater cost of ownership for customers, and greater warranty costs for manufacturers and suppliers. For instance, a major cost associated with operating remotely located food service equipment has to do with the wide geographic distribution of such equipment, and the necessity of manual inspection ensure that machines are operating properly. This cost can be significantly reduced through use of automatic remote monitoring designed to provide timely information to facilitate timely and efficient equipment maintenance.

It is to be understood equipment complexity, personnel turnover, energy costs, and food safety considerations are causing food service store operations margins to decline. Equipment owners require intelligent machines to assist in improving profitability of their food service equipment investment.

### BRIEF DESCRIPTION OF THE DRAWINGS

So that those having ordinary skill in the art, which the present invention pertains, will more readily understand how to employ the novel system and methods of the present invention, certain illustrated embodiments thereof will be described in detail herein-below with reference to the drawings, wherein:

FIG. 1 is a system diagram of an exemplary embodiment of a system for a machine management ecosystem;

FIG. 2 illustrates an exemplary process utilizing the embodiment of FIG. 1;

FIG. 3 illustrates an exemplary process utilizing the embodiment of FIG. 1; and

FIG. 4 illustrates an exemplary computing device and the components thereof which may be utilized in certain embodiments herein.

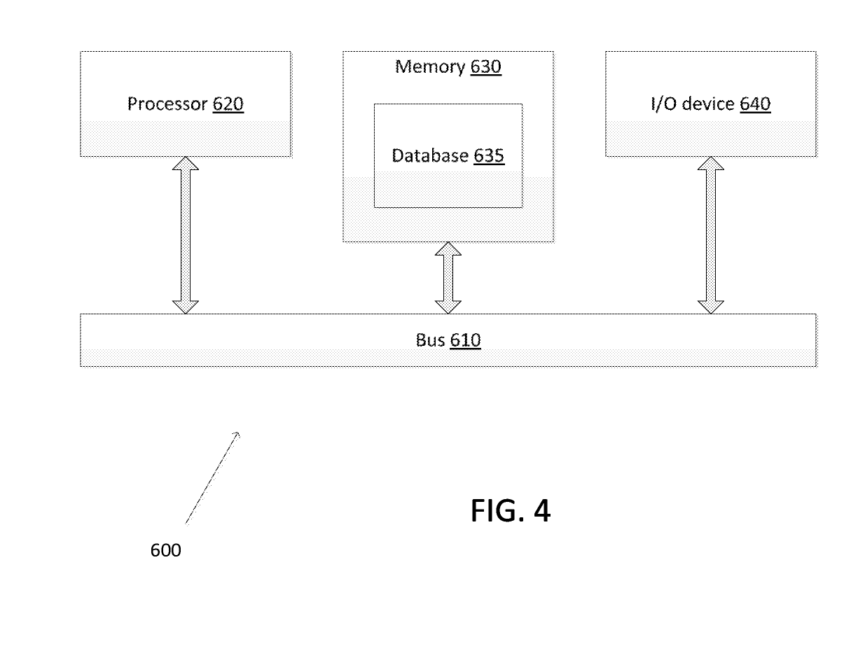

### SUMMARY OF THE INVENTION

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings.

To achieve these and other advantages and in accordance with the purpose of the illustrated embodiments, in one aspect, a communication module (e.g., wireless) is connected to preferably food service machines in which a user can remotely monitor and communicate with machine to track energy usage, warranty data, service data, performance data, etc.

In accordance with certain illustrated embodiments, a communication module which includes, but is not to be limited to: a 3G Radio, wi-fi, radio frequency capability (RF), and an antenna with expansion capabilities; are provided as plug-in modules to food service machines for enabling additional functionality by providing connectivity to and from the food service machines either through cellular communication or wi-fi. The communication module may connect to the Internet via Wi-Fi and an access point (customer provided) or through its internal cellular radio. The communication module preferably communicates to an equipment controller of the food service machine, via serial communications. The communication module is configured and operative to parse out pertinent operating data of the food service machine and transmit it to a centralized database.

The database preferably stores this information and produces reports (on demand or automated). The database can also send email alarms regarding real-time or future performance of food service machines. A user accesses machine information through the database, either via computer or other internet browser capable device (there is preferably no direct connection to an machine). The communication module is configured and operative to automatically send data from the machine to the database at preferably predetermined time intervals. The communication module can also be configured to query the database to see if there are any actions for it to perform (e.g., obtain a real time data set). The system is configurable to encompass smart phone/tablet applications and dashboard pc applications to present the data in an intuitive and actionable form.

Advantages provided by the certain illustrated embodiments, include, but are not limited to, providing a traceable view for users of various levels in the product life chain of a food service machine which reduces total cost of ownership. Further advantages include linking the stages of the equipment life cycle from factory build to end use and enabling equipment performance tracking, service data connection, and warranty data connection. It is noted users of the system include the end operator, the customer headquarters, the service/distributor network, and the equipment manufacture. Applications integrated with the machines include energy management for usage trend prediction, asset management (where is the equipment located or what is the cost of ownership), quality and service management (electronic work orders, speed of service, fixed right first time, trends in failures), and prognostic/diagnostic tools to reduce downtime of the equipment, and automatic updates to equipment application software, preventative maintenance and software configuration/updates can be communicated to a machine thus eliminating the cost of a service call.

### DETAILED DESCRIPTION OF CERTAIN EMBODIMENTS

In accordance with the below illustrated embodiments, described herein is a communication system and method for providing remote machine (e.g., a food service machine) management. It is noted that a component or feature that is common to more than one drawing is indicated with the same reference numeral in each of the drawings. It is also to be appreciated certain embodiments are described below more fully with reference to the accompanying drawings. However, the illustrated certain embodiments are not limited to what is shown therein as they are merely illustrated for exemplary purposes as the certain illustrated embodiments can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the certain illustrated embodiments. Furthermore, the terms and phrases used herein are not intended to be limiting but rather to provide an understandable description of the certain illustrated embodiments.

Unless defined otherwise, all technical and scientific terms used herein have the same meaning as commonly understood by one of ordinary skill in the art relating to the certain illustrated embodiments. Although any methods and materials similar or equivalent to those described herein can also be used in the practice or testing of the certain illustrated embodiments, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the certain illustrated embodiments discussed below are preferably a software algorithm, program or code residing on computer useable medium having control logic for enabling execution on a machine having a computer processor. The machine typically includes memory storage configured to provide output from execution of the computer algorithm or program. As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. Computering devices described herein may encompass, but are not limited to, a personal computer, a tablet device, smart phone device, a server, a router, a network PC, a peer device, or other common network node. One skilled in the art will appreciate further features and advantages of the certain illustrated embodiments based on the above-described embodiments. Accordingly, the certain illustrated embodiments are not to be limited by what has been particularly shown and described, except as indicated by the appended claims.

Generally, the methods described herein mitigate downtime for electronic machine by optimizing an effective and timely response to problems. Preferably, each machine is capable of self-monitoring and reporting any problems detected, including information about the specific problem discovered. Examples of machine 300, include, but are not limited to residential and commercial kitchen machines (e.g., refrigerators, freezers, cooking grills, frozen beverage dispensers, cooking ovens and ice cream dispenser machines), however, it is contemplated herein that machine 300 may comprise any piece of equipment. Thus, remotely located service personnel have the information necessary to diagnosis repairs and/or determine hardware components necessary to repair the machine. It is to be understood the below described system of the certain illustrated embodiments preferably gathers information about the machines, including their current operating parameters, providing certain uses, including, but not limited to, assisting manufacturers to more effectively design future products.

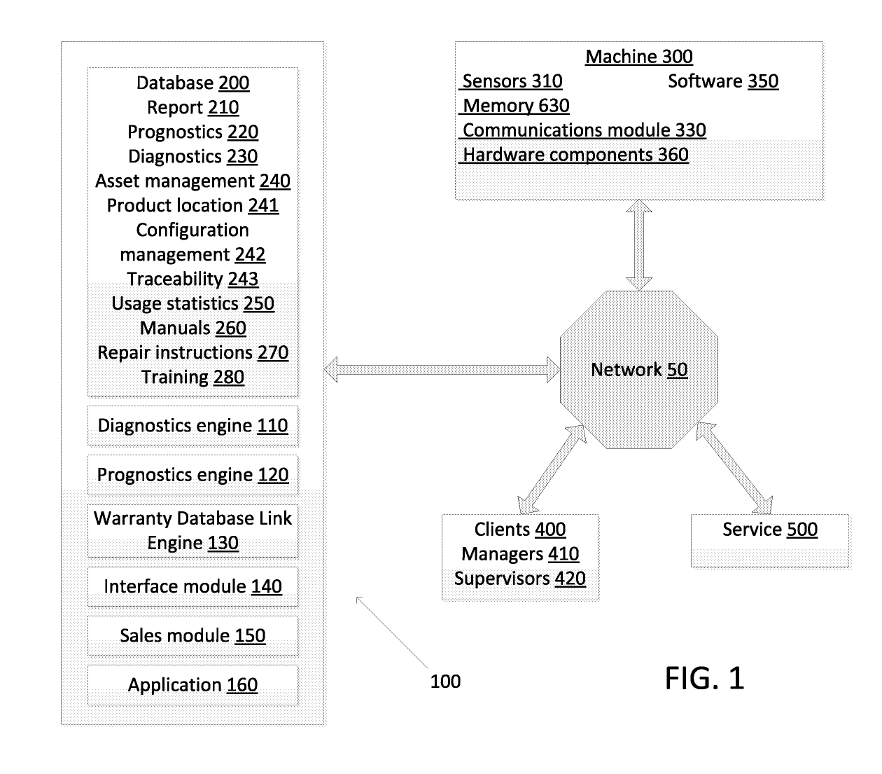

Referring now to FIG. 1, a hardware diagram depicting a management system 100 in which the processes described herein can be executed is provided for exemplary purposes. In one example, management system 100 includes network 50 (as described further below), database 200, a client 400, and a machine service center 500. Management system 100 further includes diagnostics engine 110, prognostics engine 120, warranty database link engine 130, communication interface module 140, sales module 150, application 160, and database 200. Database 200 preferably includes report information 210, prognostics information 220, diagnostics information 230, asset management 240 that includes product location 241, configuration management 242, and traceability 243, usage statistics 250, manuals 260, repair instructions 270, and training information 280, all preferably relating to a certain machine (e.g., food service machine) type. A client 400 preferably includes managers 410, supervisors 420, and subscription 430. Machine 300 preferably includes one or more sensors 310, memory 630, communication module 330, operating software 350, hardware components 360, and update 370, wherein operating software 350 preferably includes failure code 351, temperature 352, power usage 353, and timing information 354 pertaining to operation of a machine 300. It is noted that for ease of illustration purposes, only a single machine 300, client 400 and service center 500 are shown in FIG. 1, and it is to be understood the illustrated embodiment is not to be limited thereto as network 50 may be coupled to plural machines 300, client 400 and service center 500.

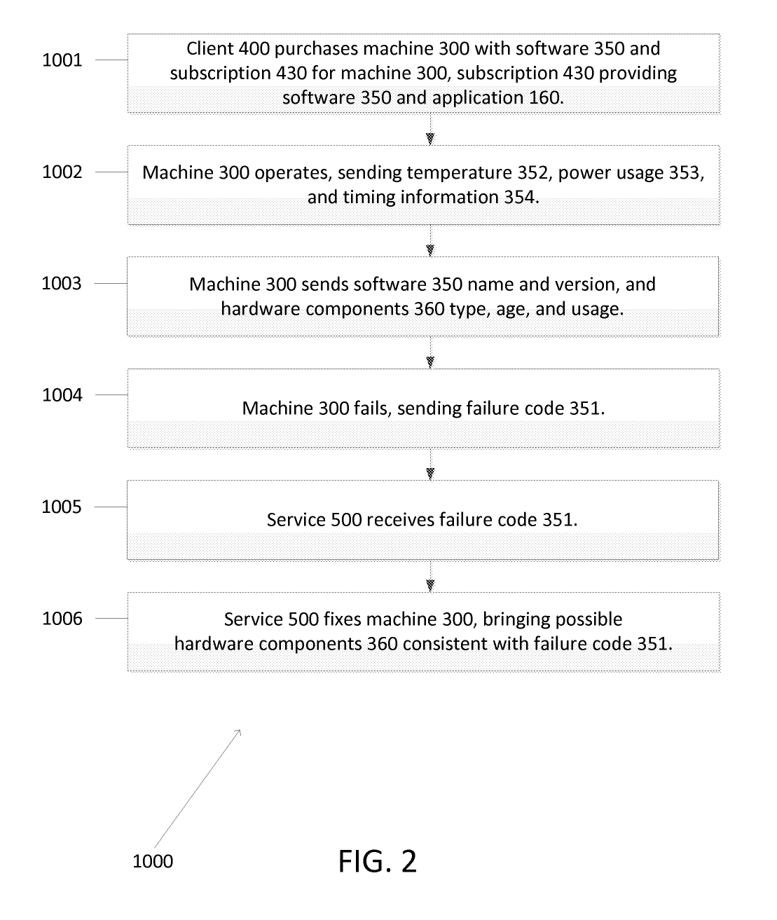

Turning now more particularly to FIG. 2, illustrated therein is exemplary process 1000 for utilizing management system 100. Starting at step 1001, client 400 purchases machine 300 having software 350 and a subscription plan 430. The purchase of subscription plan 430 preferably providing software application modules 160 that communicates with machine 300. Software 350 preferably includes an operating system executing on machine 300, but it is also contemplated herein that software 350 may be management software executing on machine's 300 operating system. Software application modules 160 preferably includes a software program that is installed on system 100.

Proceeding to step 1002, machine 300 operates during which it preferably generates and transmits temperature 352, power usage 353, and timing information 354 amongst other possible operating parameters. Timing information 354 preferably includes information such as, for exemplary purposes only and without limitation, the time duration machine 300 requires to heat up to a target temperature, time required for machine 300 to maintain a target temperature, time duration a door on machine 300 remains open, time duration machine 300 remains in a given mode of operation (e.g., standby mode, cool down mode, active mode), and/or other operating information. Power usage 353 preferably includes how much electrical power machine 300 utilizes, including, for exemplary purposes only, how much electrical power is necessary to reach a target temperature within machine 300, and how much electrical power is necessary to maintain a target temperature within machine 300. Temperature 352 preferably consists of the operating temperature 352 of machine 300 while ambient temperature 352 preferably consists of the ambient temperature 352 surrounding machine 300, and/or other such temperature related information.

Proceeding to step 1003, machine 300 preferably communicates software 350 name and version, hardware components 360 type, age, and usage information. Software 350 version preferably indicates what version/patch is installed on machine 300. Hardware components 360 type, age, and usage information preferably includes information such as the type of each hardware component 360, the date hardware component 360 was manufactured, when hardware component 360 was installed, and/or how much time hardware component 360 has been utilized at what percent of a prescribed maximum tolerance.

Proceeding now to step 1004, when machine 300 fails, it preferably transmits sends failure code 351, via network 50, to service location 500. Remotely located service location 500 then receives the one or more failure codes 351 (step 1005). The one or more failure codes 351 preferably indicates what hardware component 360 is indicated to be malfunctioning, preferably per sensor 310. Thus service center 500 is provided an indication of which hardware component(s) 360 may need to be replaced and/or adjusted, thus enabling service center 500 to dispatch the appropriate hardware component(s) 360 and/or adjustments needed on the service call to remotely located machine 300. Thereafter a technician preferably dispatched from service center 500 preferably repairs machine 300 requiring service (step 1006). Alternatively to a technician being dispatched from service center 500, service center 500 may perform remote adjustments to operating parameters on machine 300, via network 50 and software 350 in certain situations wherein the physical presence of a service technician is not required (e.g., no replacement hardware is required).

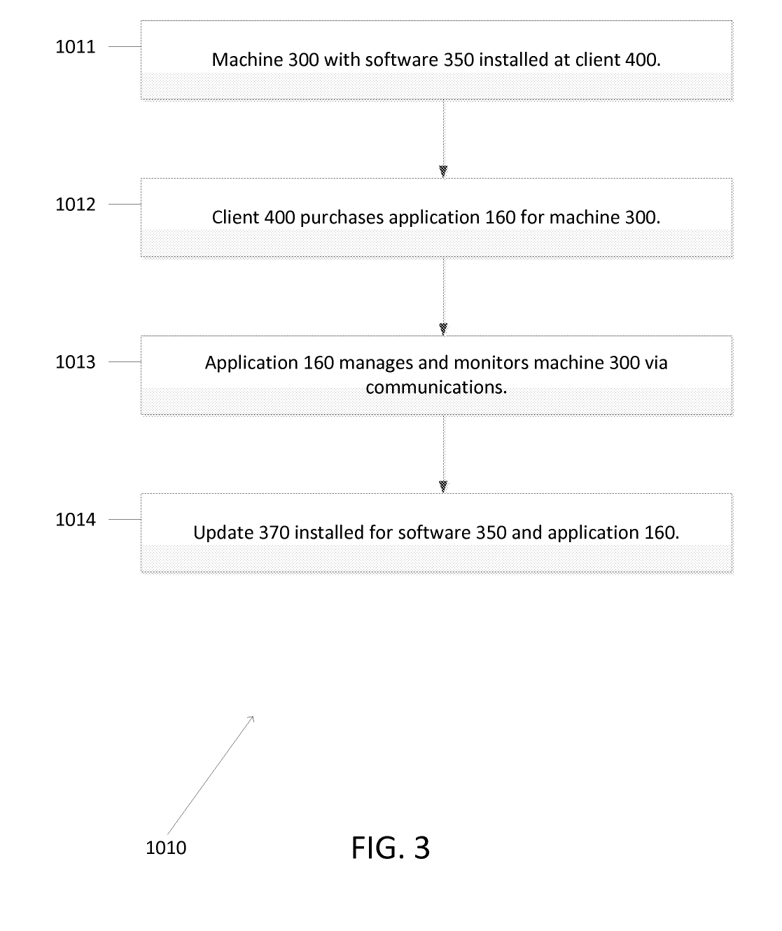

Turning now to FIG. 3, illustrated therein is exemplary process 1010 for utilizing management system 100. Starting at step 1011, machine 300 is installed at a client location 400 in which a client 400 preferably purchases a various software application modules 160 to communicate with machine 300 (step 1012). It is to be appreciated application modules 160 preferably includes a power management application, a safety application, a service application, and a customer loyalty application. The power management application 160 preferably monitors power usage of machine 300, and it may also be configurable to minimize power usage of machine 300. For exemplary purposes, power management application 160 may determine that customary usage of machine 300 indicates that temperature 352 of machine 300 is very often, but not always, above 350 degrees from 6:00 PM to 10:30 PM, thus the power management application 160 does not allow temperature 352 to fall below 350 degrees, thus reducing the power necessary to reheat machine 300. The safety application module 160 preferably monitors, via communication with sensor 310, information such as the temperature 352 machine 300 has been operating at. For example, if machine 300 is a refrigerator/freezer, the safety application 160 may indicate a failure code 351 if temperature 352 raises above a specified level. Service application module 160 preferably monitors machine 300, including operating software 350 and hardware components 360, to detect problems therewith, or possibly anticipate problems. For example, service application module 160, via sensor 310, may determine that a specific hardware component 360 has been progressively functioning below a threshold value(s) whereby software application module 160 is configured and operative to determine possible future failure of a hardware component 360 by sending failure code 351. In one embodiment, customer loyalty application module 160 may provide the functionality of allowing customers to identify themselves to machine 300, e.g., by swiping a customer card. Subsequently, machine 300 for instance, may produce a customer's favorite or preferred food selection, and also increase the total of the customer's business, thus allowing the customer to receive a loyalty bonus.

At step 1013, one or more software application modules 160 communicate with machine 300. Additionally, update software module 370 are installed on machine 300 (step 1014). Update software module 370 is preferably configured to update the operating software 350 for machine 300. It is contemplated herein that software update module 370 preferably includes software updates, firmware updates, and driver updates. It is further contemplated herein that software update module 370 may be “pushed” from system 100 to machine 300 (via network), or software update module 370 may be “pushed” from a third party server to machine 300, or software update module 370 may be requested periodically by machine 300 until such time as software update module 370 is created and/or published.

Warranty database link engine 130 communicates, via interface module 140, with machine 300 to acquire, preferably automatically, failure history of machine 300. Warranty database link engine 130 also communicates with another computing device (not shown) to relay information such as failure history of machines 300 that warranty database link engine 130 has received information from.

Sales module 150 provides and manages product loyalty programs as well as billing and invoice services and applications.

In accordance with an illustrated embodiment, communications module 330 on machine 300 preferably includes Wi-Fi capabilities and/or components enabling it to communicate over cell-phone networks. Thus, in one embodiment, communications module 330 initially communicates with system 100 via a Wi-Fi network onsite with machine 300. If the Wi-Fi network is non-functioning, communications module 330 communicates to system 100 over a cell phone network, such as 3G, 4G (LTE), or other standards and/or protocols as used in the field. If neither Wi-Fi nor cell phone communications are working, communications module 330 is radio frequency (RF) enabled to conduct communications. It is contemplated herein that communications module 330 may have the functionality to communicate with system 100 via any means, either currently known or developed in the future.

The terms “module” and “engine” are used herein to denote a functional operation that may be embodied either as a stand-alone component or as an integrated configuration of a plurality of subordinate components. Thus, for exemplary purposes only, diagnostics engine 110 and sales module 150 may be implemented as a single engine/module or as a plurality of engines/modules that operate in cooperation with one another. Moreover, although diagnostics engine 110 and sales module 150 are described herein as being implemented as software, they could be implemented in any of hardware (e.g. electronic circuitry), firmware, software, or a combination thereof.

Memory 630 is a computer-readable medium encoded with a computer program. Memory 630 stores data and instructions that are readable and executable by processor 620 for controlling the operation of processor 620. Memory 630 may be implemented in a random access memory (RAM), volatile or non-volatile memory, solid state storage devices, magnetic devices, a hard drive, a read only memory (ROM), optical storage, or a combination thereof.

Processor 620 is an electronic device configured of logic circuitry that responds to and executes instructions. The processor 620 could comprise more than one distinct processing device, for example to handle different functions within I/O device 640. Processor 620 outputs results of an execution of the methods described herein. Alternatively, processor 620 could direct the output to a remote device (not shown) via network 50.

It is to be further appreciated that network 50 depicted in FIG. 1 can include a local area network (LAN) and a wide area network (WAN), but may also include other networks such as a personal area network (PAN) and/or a sub-network access protocol (SNAP). Such networking environments are commonplace in offices, enterprise-wide computer networks, intranets, and the Internet. For instance, when used in a LAN networking environment, the system 100 is connected to the LAN through a network interface or adapter (not shown). When used in a WAN networking environment, the computing system environment typically includes a modem or other means for establishing communications over the WAN, such as the Internet. The modem, which may be internal or external, may be connected to a system bus via a user input interface, or via another appropriate mechanism. In a networked environment, program modules depicted relative to the system 100, or portions thereof, may be stored in a remote memory storage device such as storage medium. It is to be appreciated that the illustrated network connections of FIG. 1 are exemplary and other means of establishing a communications link between multiple computers may be used.

It should be understood that computing devices 600 each generally include at least one processor, at least one interface, and at least one memory device coupled via buses. Computing devices 600 may be capable of being coupled together, coupled to peripheral devices, and input/output devices. Computing devices 600 are represented in the drawings as standalone devices, but are not limited to such. Each can be coupled to other devices in a distributed processing environment.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof.

Although the systems and methods of the subject invention have been described with respect to the embodiments disclosed above, those skilled in the art will readily appreciate that changes and modifications may be made thereto without departing from the spirit and scope of the subject invention as defined by the appended claims.

What is claimed is:

1. A computer implemented method for remotely managing one or more machines each having operating software and a communication module, the method comprising the steps of:
establishing communication via a network between a remote computer device and a communication module of the one or more machines; and
communicating with the operating software of the one or more machines to determine operating parameters of the one or more machines in the remote computer device.

2. A method as recited in claim 1, wherein the one or more operating parameters include a failure code representative of faulty operation of a machine.

3. A method as recited in claim 2, wherein the failure code is further representative of a faulty hardware component of a machine.

4. A method as recited in claim 3, further including the step of determining a replacement hardware component for a machine needed to rectify the failure code.

5. A method as recited in claim 1, wherein the one or more operating parameters include a failure code representative of faulty operation of software provided in a machine.

6. A method as recited in claim 1, wherein the operating parameters is selected from the group consisting of: machine operating temperature; ambient temperature surrounding a machine; and operation time.

7. A method as recited in claim 1, wherein the one or more machines is selected from the group consisting: refrigerators, freezers, cooking grills, frozen beverage dispensers, cooking ovens and ice cream dispenser machines.

8. A method as recited in claim 1, further including the step of determining in the remote computer a location of each of the one or more machines.

9. A method as recited in claim 1, further including the step of running a software application module as selected by the user wherein each selected software application module monitors, and receives from one of the one or more machines, a specific operating feature of the one or more machines.

10. A method as recited in claim 1, further including the step of sending a version identification of the operating software provided with the one or more machines.

11. A method as recited in claim 1, further including the step of sending an assigned name and a version of the one or more machines.

12. A method as recited in claim 1, further including the step of transmitting an age of at least one hardware component of the one or more machines to the remote computer via the network.

13. A method as recited in claim 1, further including the step of transmitting a usage history of at least one hardware component of the one or more machines to the remote computer via the network.

14. A method as recited in claim 13, wherein the usage history of the at least one hardware component pertains to a user selected hardware component.

15. A method as recited in claim 1, further including the step of transmitting a usage history of at least one appliance to the remote computer via the network.

16. A method as recited in claim 15, wherein the usage history of the at least one appliance pertains to a user selected appliance.

17. A method as recited in claim 1, further including the step of performing remote diagnostics from the remote computer device on the one or more machines.

18. A method as recited in claim 1, further including the step of generating an alert message by the remote computer device regarding operation of the one or more machines based upon the determined operating parameters of the one or more machines.

19. A method as recited in claim 1, further including the step of transmitting operating parameters of the one or more machines to the remote computer device at prescribed time intervals without user intervention.

20. An appliance management system comprising memory, a processor and a sales module, the sales module communicating the purchase of a kitchen appliance to the management system's memory such that the processor is able to determine usage statistics of purchased and installed machines.
